(19) United States
(12) Patent Application Publication
(10) Pub. No.: US 2003/0136826 A1
(43) Pub. Date: Jul. 24, 2003

(54) Identity postage stamp

(76) Inventor: George Calvin Turner, Springfield, VA (US)

Correspondence Address: GEORGE C. TURNER, 6813 HACKBERRY ST., SPRINGFIELD, VA, 22150, US

(21) Appl. No.: 10/281,187

(22) Filed: Oct. 28, 2002

Related U.S. Application Data
(60) Provisional application No. 60/330,666, filed on Oct. 26, 2001.

(51) Int. Cl. G07G 1/00; G06K 19/06

(52) U.S. Cl. 235/101; 235/494

(57) ABSTRACT

The present invention is to establish capabilities to identify and verify each sender of a mailed item(s) through the use of Encrypted Identity Postage Stamps, labels or preaddressed envelopes. The use of identity stamps will improving the security of the United States Postal System, and it will also provide a greater feeling of calm to individuals receiving mail, and provide the basis to establishing a National Tracking System. Each stamp will be scannable and will contain personal information imbedded in or on each stamp. To purchase stamps, individuals will have to register with the Post Master General and provide their name, current and previous addresses for the last five or ten years. Additional personal information such as photo, finger prints (two or more fingers incase of accidents), DNA (can be optional), iris identification and other sources of identification as technologies become available and perfected may also be imbedded in each.

### FINGER PRINTS

An identification block will permit finger printing of each mailer. The Postal Service may scan each letter for a finger print and correct postage. Mail without proper identification will be returned to the sender, destroyed, or reprocessed through a cleansing or sterility process. The fingering print block will incorporate current or future finger printing technology.

### PHOTO IDENTIFICATION

Computer generated photos will be on file with the postal service. The identification block will contain computer codes that will permit generating a photo and address of the sender.

Physical photos of the mailer may also be an option, which may be copied into envelope or stamps and labels.

Eye Imaging

Identification block will contain eye imaging identification capabilities.

DNA Identification

Optional—DNA data prints may also be implanted into the stamps under certain circumstances.

1. The postage identity stamps are intended to provide a tracking mechanism to identify senders of items through the postal system:
To implement tracking capabilities, the stamps will contain personal information on each purchaser of stamps. The information may include all or partial data such as: name, address (current and previous), social security number, date of birth, finger prints, photo-digital, DNA data, eye (iris) identification, e-mail address (s) and/or next of kin and or contact person, and/or family members.
The stamps will be scannable, with encrypted personal data.
The size and shape of the stamps may vary, depending on the amount of data entered, and creativity of designs.
The stamps will continue to be stick-on or glue-on.
In addition to encrypted personal data, stamps may also include one or a combination of the following: finger printed seal, photo-digital imaging plate, eye imaging plate or DNA plate.
When or if required during special alert periods or for special circumstances, the identity stamps may appear as regular stamps, but will also contain a sealed ink pad to permit embedding a finger print. The ink pad will have a removable film to keep the ink moist until implanting the finger into the ink.
In addition to scannable personal data, postal prices and other information the Post Master may deem necessary to process mail, and it must allow marking to indicate previous usage.
